(19) United States
(12) Patent Application Publication
(10) Pub. No.: US 2013/0282701 A1
(43) Pub. Date: Oct. 24, 2013

(54) Network Searching Method of Mobile Terminal and Mobile Terminal

(71) Applicant: Zhibing Yang, Huizhou (CN)

(72) Inventor: Zhibing Yang, Huizhou (CN)

(21) Appl. No.: 13/997,968

(22) PCT Filed: Mar. 16, 2012
(86) PCT No.: PCT/CN2012/072441

§ 371 Date: Jun. 25, 2013

(30) Foreign Application Priority Data
Mar. 17, 2011 (CN) 201110064465.X

(51) Int. Cl. G06F 17/30

(52) U.S. Cl. CPC G06F 17/30554
USPC 707/722

(57) ABSTRACT

A mobile terminal and a network searching method of the mobile terminal are disclosed. The network searching method of a mobile terminal may include the following steps: when a character string to be searched appears on a text browsing interface, switching the text browsing interface to a status in which the character string is selectable and acquiring the character string to be searched that a user selects; converting the character string to be searched to a URL; sending the URL comprising the character string to be searched to a network server and receiving a search result returned according to the URL by the network server; and displaying the search result in the form of a web page.

### TECHNICAL FIELD

The present invention relates to a search method on a network, and in particular relates to a mobile terminal and a network search method of the mobile terminal.

### BACKGROUND ART

With the coming of an information age, performing a search on a network has become an essential part of human daily lives, and provides much convenience to human lives. It has become a habit to turn to Baidu, and Google. When encountering an unknown word, place or matter, people can open a search webpage, input an expression that needs to be searched, and then click on the search to find the related information.

With the coming of the 3G age, performing search on a network by a mobile phone has become more and more popular for users. When encountering an unknown word, place or matter during the process of reading an ebook reader, browsing a web page or reading a short message, the user on the mobile phone will conduct a search via a network search engine.

However, in the traditional search method, the word to be searched must be remembered first, and then one exits from a current application, opens the search engine web page, inputs the word that needs to be searched, and clicks a search to perform a search. Then one may exit from the search engine web page, and go into the application before the search is started. It can be seen that the existing search method has many inconveniences, especially when the content that needs to be searched is difficult to enter with an input method. Therefore a search method like this may be complicated and inefficient.

### SUMMARY OF THE INVENTION

The present invention mainly solves the complicated process and low efficiency problem of the network search on the text browsing interface by providing a mobile terminal and a network search method of the mobile terminal.

A technical solution provided by the present invention to solve the above mentioned technical issue is: providing a network search method of a mobile terminal, and the network search method of a mobile terminal comprises the following steps: when a character string to be searched appears on a text browsing interface of a short message, an email and/or an ebook reader, switching the text browsing interface to a status in which the character string can be selected; acquiring the character string to be searched that a user selects; converting the character string to be searched to a URL; sending the URL comprising the character string to be searched to a network server; receiving a search result returned by the network server according to the URL; and displaying the search result in the form of a web page.

After the step of displaying the search result in the form of a web page, the method includes returning back to the original text browsing interface after the web page displaying the search result is closed.

Another technical solution employed in the present invention in order to solve the above mentioned technical issue is: providing a network search method of a mobile terminal. The network search method of a mobile terminal comprises the following steps: when a character string to be searched appears on a text browsing interface, switching the text browsing interface to a status in which the character string can be selected; acquiring the character string to be searched that a user selects; converting the character string to be searched to a URL; sending the URL comprising the character string to be searched to a network server; receiving a search result returned by the network server according to the URL; and displaying the search result in the form of a web page.

The text browsing interface comprises a browsing interface of a short message, an email or an ebook reader.

In response to a character string to be searched appearing on a text browsing interface switching the text browsing interface to a status in which the character string can be selected and acquiring the character string to be searched that a user selects, a step may comprise: in response to the mobile terminal supporting a touch screen mode, performing an action of long pressing and/or dragging on the touch screen by the user to acquire the corresponding character string to be searched. When the mobile terminal does not support the touch screen mode, an action is performed of moving the cursor through a physical key by the user to acquire the corresponding character string to be searched.

The selected character string to be searched is stored in an array after the character string to be searched appears on a text browsing interface, after the text browsing interface is switched to a status in which the character string can be selected and after acquiring the character string to be searched that a user selects.

The start of the search via an option of “start search” is confirmed after the character string to be searched appears on a text browsing interface, the text browsing interface is switched to a status in which the character string can be selected and the character string to be searched that a user selects is acquired.

The method further includes after the step of displaying the search result in the form of a web page: returning back to the original text browsing interface after the web page displaying the search result is closed.

A further technical solution employed in the present invention in order to solve the above mentioned technical issue is: providing a mobile terminal comprising a text browsing module, a browser module and a network module. The text browsing module is used, in response to a character string appearing on a text browsing interface, to switch the text browsing interface to a status in which the character string can be selected and acquire the character string to be searched that a user selects. The browser module is used to convert the character string to be searched, which is acquired by the text browsing module, to a URL. The network module is used to send the URL comprising the character string to be searched, which is converted by the browser module, to a network server and receives a search result returned by the network server according to the URL. Then the search result is displayed in the form of a web page by the browser module.

If the mobile terminal supports a touch screen mode, an action is performed by the text browsing module of long pressing and/or dragging on the touch screen by the user to acquire the corresponding character string to be searched. If the mobile terminal does not support the touch screen mode, an action is performed by the text browsing module of moving the cursor through a physical key by the user to acquire the corresponding character string to be searched.

An option of “start search” is set on the text browsing interface, which is used to confirm the start of the search after the character string to be searched is selected.

The browser module returns back to the original text browsing interface when the web page displaying the search result is closed.

The network search method of a mobile terminal and the terminal of the present invention switches a text browsing interface to a status in which a character string can be selected and then selects the character string to be searched via the function of the text browsing module, and then sends a search request to a network server through the browser module, and network module. The network server returns a search result and displays the search result to the user in the form of a web page. The present invention is capable of implementing a fast network search for a character string to be searched on a text browsing interface such as a short message, an email or an ebook reader.

### DESCRIPTION OF THE DRAWINGS

FIG. 1 is a diagram showing information interactions between the modules of the present invention.

FIG. 2 is an operation flow chart of a network search method of a mobile terminal according to the present invention; and

FIG. 3 is a flow chart of a network search method of a mobile terminal according to the present invention.

### DETAILED DESCRIPTION OF THE INVENTION

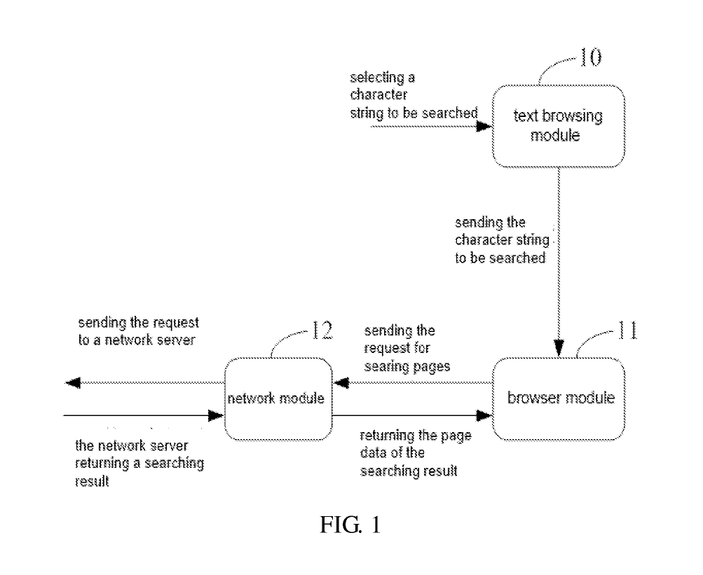

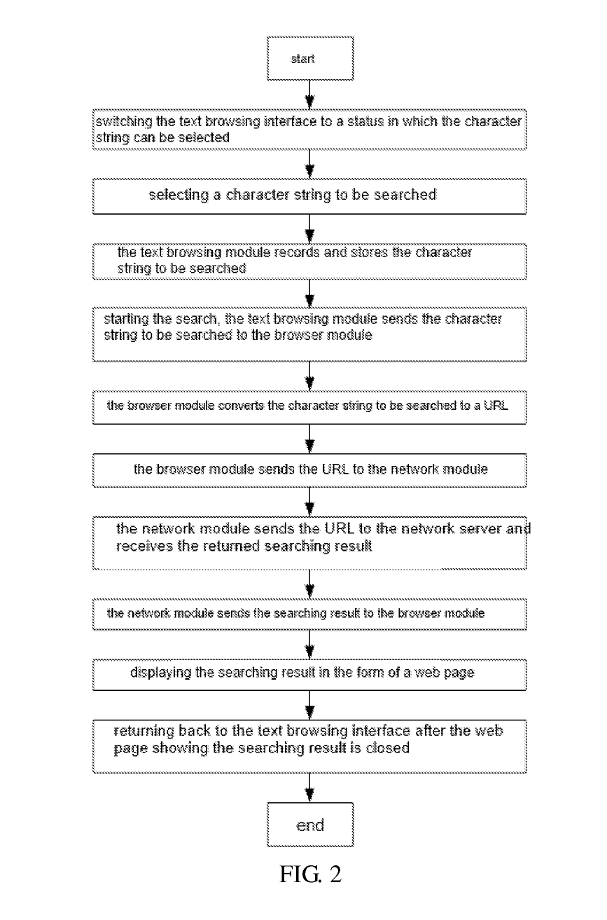

FIG. 1 is a diagram showing information interactions between the modules of the present invention. FIG. 2 is an operation flow chart of a network search method of a mobile terminal according to the present invention.

The mobile terminal (unmarked) comprises a text browsing module 10, a browser module 11 and a network module 12. The text browsing module 10 is electrically connected to the browser module 11, while the browser module 11 is electrically connected to the network module 12. The text browsing module 10 outputs a text browsing interface to display the text content for browsing.

After a character string to be searched appears on the text browsing interface, the text browsing module 10 switches the text browsing interface to a status in which a character string can be selected, selects the character string to be searched and stores the character string to be searched into an array in the text browsing module 10, and then the text browsing module 10 sends the character string to be searched to the browser module 11.

The browser module 11 converts the character string to be searched into a URL (website, Universal Resource Locator), and sends the URL to the network module 12.

The network module 12 sends the URL to a network server (not shown in the Figures), receives a search result returned by the network server, and then sends the search result to the browser module 11. The browser module 11 displays the search result in the form of a web page.

The text browsing module 10 can be a text browsing module 10 of a short message, an email or an ebook reader.

In addition, an option of “start search” is included in the text browsing interface. After the text browsing interface is switched to a status in which a character string can be selected, this option may allow a user to confirm the start of the search after the character string has been selected by the user.

During the process of selecting a character string to be searched, in response to the mobile terminal supporting a touch screen mode, an action is performed of long pressing and/or dragging on the touch screen by the user to acquire the corresponding character string to be searched, and the selected character string is displayed in a highlighted form. If the mobile terminal does not support the touch screen mode, an action is performed of moving the cursor through a physical key by the user to acquire the corresponding character string to be searched.

For instance, if a user is browsing a text browsing interface of a short message, an email or an ebook reader, if a character string to be searched appears, different methods can be used to select the character string to be searched:

In a first method, if the mobile terminal supports the touch screen mode, the method may include performing a long press at the position before or after the character string to be searched. The text browsing module 10 switches the text status of the current text browsing interface from a reading status to a status in which the character string can be selected, after receiving the message that the touch screen is pressed for a long time. The characters in the current text browsing interface are then selectable, and the position currently pressed by the user is recorded with respect to the coordinate reported by the touch screen. The user selects the character string to be searched by dragging, and the text browsing module 10 acquires the character string selected from the start position to a current position according to the touched coordinate on the touch screen. The text browsing module 10 updates the coordinates to the coordinates of the elected character string after the dragged or touched coordinate is changed, and stores the selected character string into an array of the text browsing module 10;

In a second method, if the mobile terminal does not support the touch screen mode, a user moves the cursor on the text browsing interface to a specific position (that is the position at the character string to be searched), and chooses the option of “select text” on the text browsing interface. Then the text browsing module 10 switches the reading status of the text browsing interface to a status in which a character string can be selected, and the user selects the character string to be searched by moving the cursor with a physical key. The text browsing module 10 recodes the currently selected character string after each movement of the cursor, and stores the selected character string to an array of the text browsing module 10.

The character string to be searched may be selected through above mentioned two methods, and the mobile terminal of the first method which supports the touch screen mode can also conduct the character selection with the second method.

Next, the text browsing interface may be refreshed, and the selected character string may be highlighted.

After the character string to be searched has been selected, the option of “start search” is chosen as a request for starting the search. The text browsing module 10 sends the character string to be searched in the array to the browser module 11. After the receipt of the character string to be searched, the browser module 11 takes the character string to be searched as the entry for the search and converts it into a URL according to a certain format, for instance if searching for “morning” via Baidu, the converted URL can be: http://www.baidu.com/s?wd=morning. The browser module 11 uses the converted URL as the web site for a web search to open a new web page. In other words it sends a request to a network server of a search engine with the URL, and then the browser module 11 encodes the request for accessing a web page from the user and sends the request to the network module 12.

The network module 12 sends the request to the network server through a 2G, 3G or 4G network. The network server finishes the search of the user and sends the search result to the mobile terminal through a wireless network. The network module 12 in the mobile terminal sends the received search result to the browser module 11. The browser module 11 analyzes the received search result and displays the result to the user in the form of a web page.

The method then includes returning back to the original text browsing interface after the web page showing the search result is closed.

The mobile terminal of the present invention can perform a fast search simply by switching a text browsing interface to a status in which a character string can be selected and conducting selection, especially for the characters in the text browsing interface of a short message, or an ebook reader. Compared with the existing technique of network search method which is complicated and inconvenient, the present invention is capable of performing a network search quickly and easily, simplifying the complicated search process and improving user experience.

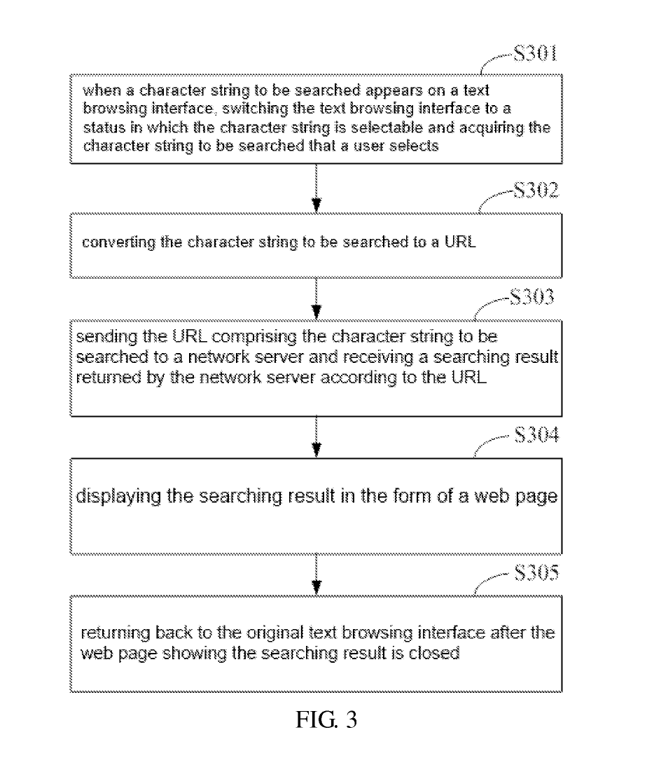

FIG. 3 is a flow chart of a network search method of a mobile terminal according to the present invention.

In the embodiment, the network search method of a mobile terminal comprises:

A step S301 may include, if a character string to be searched appears on a text browsing interface, switching the text browsing interface to a status in which the character string can be selected and acquiring the character string to be searched that a user selects.

In the step of S301, the text browsing interface comprises the browsing interface of a short message, an email or an ebook reader. In response to the mobile terminal supporting a touch screen mode, an action is performed of long pressing and/or dragging on the touch screen by the user to acquire the corresponding character string to be searched. If the mobile terminal does not support the touch screen mode, an action is performed of moving the cursor through a physical key by the user to acquire the corresponding character string to be searched. As previously mentioned, during the process of selecting the character string to be searched, if there are multiple character strings, the character strings can be stored in an array, and can be searched together uniformly after the selection. The start of the search can be confirmed via the “start search” option.

A step S302 may include converting the character string to be searched into a URL.

In the step of S302, for instance, the character string to be searched can be used as the entry for the search and converted into a URL according to a certain format, such as if searching for “morning” via Baidu, then the converted URL can be: http://www.baidu.com/s?wd=morning, as it can be understood by those skilled in this field. Therefore it will not be repeated here.

A step S303 may include sending said URL comprising the character string to be searched to a network server and receiving a search result returned by the network server according to the URL.

A step S304 may include displaying the search result in the form of a web page.

In the step of S304, the search result can be returned in the form of a short message, a multimedia message or an email, which is not limited within the scope of understanding of those who are skilled in this field.

A step S305 may include returning back to the original text browsing interface after the web page displaying the search result is closed.

The step S305 may include returning to the original browsing interface of a short message or an email without repeated operations by the user so as to make it more convenient for the user.

As for the network search method of a mobile terminal of the embodiment, please refer to the work flow of a mobile terminal described earlier. It will not be repeated as it is within the scope of understanding of those who are skilled in this field.

The network search method of a mobile terminal of the present invention can perform a fast search simply by switching a text browsing interface to a status in which a character string can be selected and then conducting selection, especially for the characters in the text browsing interface such as a short message or an ebook reader. The present invention is capable of performing a network search fast and easily, simplifying the complicated search process and improving user experience.

The above are embodiments of the present invention, and there is no intent to limit the scope of the present invention. Equivalent structures or equivalent process changes conducted according to the description and accompanying drawings of the present invention, or directly or indirectly used in other relevant technology fields, all should fall into the scope of the present invention.

1. A network search method of a mobile terminal, wherein said network search method of a mobile terminal comprises:
in response to a character string to be searched appearing on a browsing interface of a short message, an email and/or an ebook reader, switching an original text browsing interface to a status in which the character string is selectable and acquiring the character string to be searched;
converting the character string to be searched to a Universal Resource Locator URL);
sending the URL comprising the character string to be searched to a network server and receiving a search result returned by the network server according to the URL; and
displaying the search result in the form of a web page.

2. The network search method of a mobile terminal according to claim 1, further comprising:
after the step of displaying the search result in the form of a web page, returning back to the original text browsing interface after the web page displaying the search result is closed.

3. A network search method of a mobile terminal, wherein said network search method of a mobile terminal comprises:
in response to a character string to be searched appearing on an original text browsing interface, switching the text browsing interface to a status in which the character string is selectable and acquiring the character string to be searched;
converting the character string to be searched to a URL;
sending the URL comprising the character string to be searched to a network server and receiving a search result returned by the network server according to the URL; and
displaying said search result in the form of a web page.

4. The network search method of a mobile terminal according to claim 3, wherein said text browsing interface comprises:
a browsing interface of a short message, an email or an ebook reader.

5. The network searching method of a mobile terminal according to claim 3, including:
displaying the character string to be searched on the original text browsing interface;
switching the original text browsing interface to the status in which the character string is selectable; and
acquiring the character string to be searched;
in response to the mobile terminal supporting a touch screen mode, receiving an action of long pressing and/or dragging on the touch screen to acquire the corresponding character string to be searched; and
in response to the mobile terminal not supporting touch screen mode, receiving an action of moving the cursor through a physical key to acquire the corresponding character string to be searched.

6. The network search method of a mobile terminal according to claim 3, including:
displaying the character string to be searched on the original text browsing interface;
switching the original text browsing interface to a status in which the character string is selectable;
acquiring a selected character string to be searched; and
storing the selected character string to be searched to an array.

7. The network search method of a mobile terminal according to claim 3, including:
displaying the character string to be searched on the original text browsing interface;
switching the original text browsing interface to a status in which the character string is selectable;
acquiring a selected character string to be searched; and
confirming the start of the search through a start search option.

8. The network search method of a mobile terminal according to claim 3, including:
in response to the displaying of the search result in the form of a web page, returning back to the original text browsing interface after the web page displaying the search result is closed.

9. A mobile terminal, comprising:
a text browsing module, wherein in response to a character string appearing on an original text browsing interface, the text browsing module is configured to switch the original text browsing interface to a status in which the character string is selectable and the text browsing module acquires the character string to be searched that a user selects;
a browser module configured to convert the character string to be searched, to a Universal Resource Locator (URL); and
a network module configured to send the URL comprising the character string to be searched, to a network server and receive a searching result returned by the network server according to the URL, and display the search result in the form of a web page through said browser module.

10. The mobile terminal according to claim 9, wherein in response to the mobile terminal supporting a touch screen mode, the text browsing module is configured to act according to an operation of long pressing and/or dragging on the touch screen by the user, to acquire the corresponding character string to be searched; and
in response to the mobile terminal not supporting the touch screen mode, the text browsing module is configured to act according to an operation of moving a cursor through a physical key by the user to acquire the corresponding character string to be searched.

11. The mobile terminal according to claim 9, wherein the original text browsing interface includes an option of start search, which is used to confirm the start of the searching after the character string to be searched is selected.

12. The mobile terminal according to claim 9, characterized in that said browser module returns back to the original text browsing interface when the web page displaying the search result is closed.

13. The network search method of a mobile terminal of claim 1, including storing multiple ones of the character string in an array and searching them together as a single character string.

14. The network search method of a mobile terminal of claim 1, including recoding the character string after each movement of a cursor.

15. The network search method of a mobile terminal of claim 1, including switching the text browsing interface from a reading status to the status in which the character string is selectable.

16. The network search method of a mobile terminal of claim 3, including storing multiple ones of the character string in an array and searching them together as a single character string.

17. The network search method of a mobile terminal of claim 3, including recoding the character string after each movement of a cursor.

18. The network search method of a mobile terminal of claim 3, including switching the text browsing interface from a reading status to the status in which the character string is selectable.

19. The mobile terminal of claim 9, wherein the text browsing module is configured to store multiple ones of the character string in an array and search them together as a single character string.

20. The mobile terminal of claim 9, wherein the text browsing module is configured to recode the character string after each movement of a cursor.
